(19) United States
(12) Patent Application Publication
(10) Pub. No.: US 2026/0021589 A1
(43) Pub. Date: Jan. 22, 2026

(54) METHOD FOR PRECISELY DETERMINING AN OUTPUT TORQUE, AND COLLABORATIVE ROBOT

(71) Applicant: Schaeffler Technologies AG & Co. KG, Herzogenaurach (DE)

(72) Inventor: Jochen Damerau, Yokohama (JP)

(21) Appl. No.: 19/100,384

(22) PCT Filed: Jun. 23, 2023
(86) PCT No.: PCT/DE2023/100478

§ 371 Date: Jan. 31, 2025

(30) Foreign Application Priority Data
Aug. 5, 2022 (DE) 10 2022 119 730.1

(51) Int. Cl. B25J 13/08; B25J 9/16

(52) U.S. Cl. CPC B25J 13/085; B25J 9/163; B25J 13/088

(57) ABSTRACT

The invention relates to a method for precisely determining an output-side torque, in particular an output-side torque of an actuator gearing mechanism of a joint of a collaborative robot, by means of an artificial intelligence which is designed to output one or more output variables on the basis of input variables, wherein the input variables of the artificial intelligence comprise: a first angular specification which corresponds to an input-side angular position and a second angular specification which corresponds to an output-side angular position, and additionally the output variables comprise the output torque determined by the artificial intelligence. (FIG. 1)

### CROSS-REFERENCE TO RELATED APPLICATION

The present application is the U.S. National Phase of PCT Patent Application Number PCT/DE2023/100478, filed on Jun. 23, 2023, which claims priority to German Patent Application Number 10 2022 119 730.1, filed Aug. 5, 2022, the entire disclosures of which are incorporated by reference herein.

### TECHNICAL FIELD

The present disclosure relates generally to the technical field of robotics, autonomous mobile robots (AMRs), and in particular collaborative robots (cobots) and safety and precision engineering in the workplace and in assembly systems.

### BACKGROUND

Cobot systems have been used in more and more facilities in recent years. This has led to human workers increasingly sharing the same space with cobot systems. Such robots are designed with particularly collaborative properties. For example, movements should first be stopped if objects or workers are in the way to prevent damage and injuries. Stress wave gearing mechanisms (harmonic drives/harmonic gear boxes) are often used as gearing mechanisms. However, the choice of gearing mechanism is primarily a design decision.

For solid and precise control of a cobot and its articulated motors, which makes it particularly suitable for use in precision environments as well as work environments with human workers, it is necessary to measure and/or know an outgoing/output-side torque as precisely as possible.

A torque sensor is often used for this purpose. However, this is often expensive, is often very heavy, interferes with the robot's flexibility during use and increases energy consumption. In addition, it only provides one measured value, which is not further checked. This leads to uncontrolled and dangerous situations, especially if the torque sensor experiences a technical defect or emits compromised signals.

The patent specification EP 2 231 369 B1 discloses a robot and a method for monitoring the moments on such a robot. A robot is described with at least two joints and parts that can move relative to one another by means of at least one joint, wherein at least one torque-detecting sensor is arranged on at least one movable part, and wherein two sensors and redundant evaluation units for redundant evaluation are provided for redundant detection of a torque, and wherein a device is provided for switching off the robot or for triggering a safe state, if measured values of the same torque recorded by at least two sensors deviate from each other outside a specified tolerance range, wherein the two sensors in the form of full bridges with strain gauges are arranged on a gearing mechanism of the robot in such a way that they detect the same torque and are connected by means of two computer units in the form of differently designed integrated circuits with microcontrollers within a transmitting unit, in which a first check of the measured torque values is carried out. However, the solution described here has the disadvantage that two sensors are required to detect torques, which is expensive and also has a negative impact on the dynamics and weight of the robot.

From another state of the art, indirect determination via the motor current flow is known. This solution is inexpensive but highly imprecise and therefore no longer meets today's quality standards for high-performance cobot systems.

It is therefore an object of the present disclosure to further develop collaborative robot systems in such a way that they work precisely and safely, especially in shared work environments with humans. The aim is to ensure high precision and flexibility of the robots and to minimize costs as much as possible without compromising on the quality of the product and the results achieved.

### SUMMARY

The present disclosure provides the method according to claim 1. Accordingly, a method is provided for precisely determining an output-side torque, in particular an output-side torque of an actuator gearing mechanism of a joint of a collaborative robot, by means of an artificial intelligence, which is designed to output one or more output variables on the basis of input variables, wherein the input variables of the artificial intelligence comprise: a first angular specification which corresponds to an input-side angular position, a second angular specification which corresponds to an output-side angular position, and wherein additionally the output variables comprise the output torque determined by the artificial intelligence.

The artificial intelligence determines the torque output with particular precision. The precision is higher than with conventional methods. As a result, this precise measurement allows the cobot control and the motor control to work and act more precisely.

The determination does not depend on a direct measurement of the torque, for example by means of an often expensive and heavy torque sensor. If such a torque sensor is nevertheless used, the disclosure has further advantages: the redundant determination of the torque further increases the precision. The direct output of the torque sensor is an excellent way of training the AI. In addition, the solution according to the disclosure can determine the torque independently of the torque sensor, which is particularly advantageous, for example, if the latter fails. This avoids dead time and faulty and/or uncontrolled (and therefore often dangerous) behavior of the cobot.

The disclosure further provides a robot, in particular a cobot (or a structural unit for a cobot) according to claim 4. Accordingly, a cobot or cobot component is provided, comprising a robotic device, in particular a robot arm and/or an assembly system, wherein the robotic device has one or more joints which can be moved by motors, in particular servomotors, at least one gearing mechanism, in particular a reduction gearing mechanism, one or more input-side angular position sensors, in particular input-side encoders, for determining on the input side an input-side angular position with respect to a gearing mechanism, one or more output-side angular position sensors, in particular output-side encoders, for determining on the output side an output-side angular position in relation to the gearing mechanism, an electronic control system which is designed to take into account a value of a gearing mechanism-side outgoing torque during operation of the cobot, which was provided by means of an artificial intelligence on the basis of data comprising an input-side angular position of an input-side angular position sensor and an output-side angular position of the corresponding output-side angular position sensor. It should be emphasized that the concepts disclosed here are not limited to cobots, but can be used in any type of robot.

The calculations can be carried out locally and/or non-locally, in particular also distributed, for example in the context of cloud computing. The cobot according to the disclosure, which is usually local, benefits from the disclosure through improved and more precise behavior with improved work safety.

In addition, the disclosure provides an artificial intelligence system and a suitable training method. Thus, according to the disclosure, an artificial intelligence is provided for precisely determining an output-side torque, in particular an output-side torque of an actuator gearing mechanism of a joint of a collaborative robot, which is designed to output one or more output variables on the basis of input variables, wherein the input variables of the artificial intelligence comprise: a first angular specification which corresponds to an input-side angular position, a second angular specification which corresponds to an output-side angular position, and wherein additionally the output variables comprise the output torque determined by the artificial intelligence.

The AI can be trained continuously during operation, which ensures an extremely high level of training and also takes into account changes that occur over time (e.g. changes in environmental conditions or wear and tear).

Preferably, training takes into account a direct torque measurement as a target value (e.g. a measured value from a torque sensor).

Unsupervised learning has proven to be particularly suitable. In particular, good results were achieved using a multi-layer perceptron, in particular a recurrent multi-layer perceptron, as a neural network. The recurrent properties ensure sufficient feedback.

The AI can be arranged in a kind of control loop and/or feedback loop. Thus, unsupervised learning can be effectively supplemented by torque measurement as a target value.

The disclosure enormously increases the dynamic usability of cobots in changing conditions. For example, high precision after replacing spare parts on the cobot (or refurbished cobots, for example) is guaranteed by the high flexibility of the AI.

For example, the AI can consider angular velocity, speed, acceleration and temperature as additional features (input variables) to properly account for these effects. However, the disclosure is by no means limited to this.

By means of AI, the disclosure makes effects such as friction, wear, material fatigue, reversal margin, counter-reactions, other non-linear effects, manufacturing tolerances and/or individual differences in manufacturing accessible for efficient evaluation and consideration in cobot control. These effects are often difficult to simulate and even more rarely accessible to a direct and adequate mathematical description. Artificial intelligence will help overcome these problems.

The disclosure is by no means limited to the effects mentioned here (in the sense of an exhaustive list). On the contrary, a particular advantage of using artificial intelligence in this case is that the individual effects do not have to be modelled manually, but rather all of the effects that occur and all of them in the appropriate magnitude are reproduced simultaneously and directly by the AI. Through the precise and, if necessary, redundant determination of the output torque, the disclosure makes a lasting contribution to technical progress in the field of collaborative robots.

### BRIEF DESCRIPTION OF THE DRAWINGS

Preferred embodiments of the present disclosure are described below with reference to the following figures:

FIG. 1: shows a joint of a robot with input-side and output-side angular position encoder

FIG. 2: shows a joint of a robot with output-side torque sensor and output-side angular position encoder

FIG. 3: shows a schematic drawing of a drive train for a robot joint with output-side torque sensor and angular position encoders on both sides according to an embodiment of the present disclosure.

### DETAILED DESCRIPTION

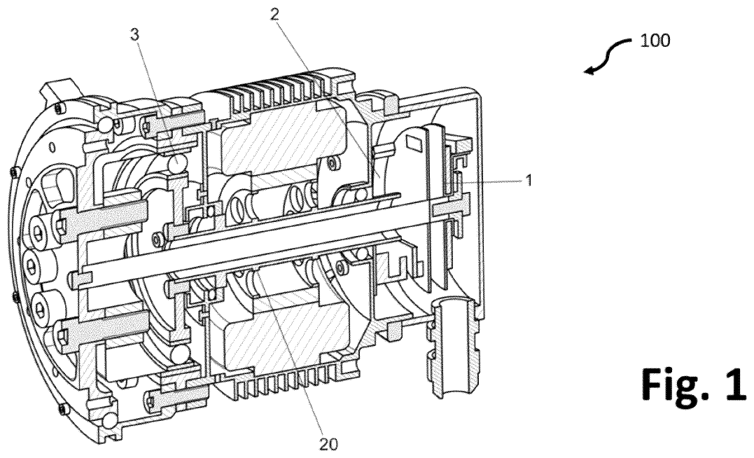

FIG. 1 shows a joint 100 of a robot with input-side and output-side angular position encoders.

In the present case, an input-side angle encoder or angular position encoder 1 is provided by the absolute encoder 1.

Furthermore, an output-side angle encoder or angular position encoder 2 is provided by the incremental rotary encoder 2.

This cobot is accessible to the disclosure thanks to the double assembly with angular position encoders.

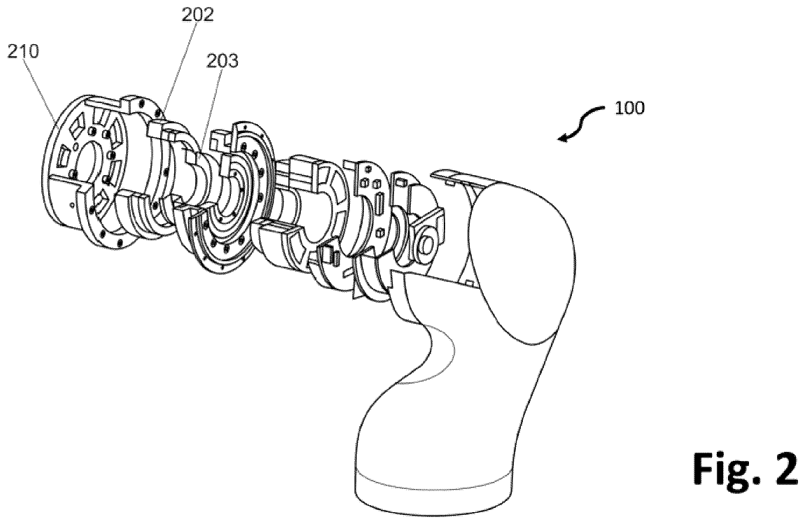

FIG. 2 shows a joint 100 of a robot with an output-side torque sensor 210 and an output-side angular position encoder 202.

A stress wave gearing mechanism, wave gearing mechanism or sliding wedge gearing mechanism 203 is used to reduce the drive train of the robot joint.

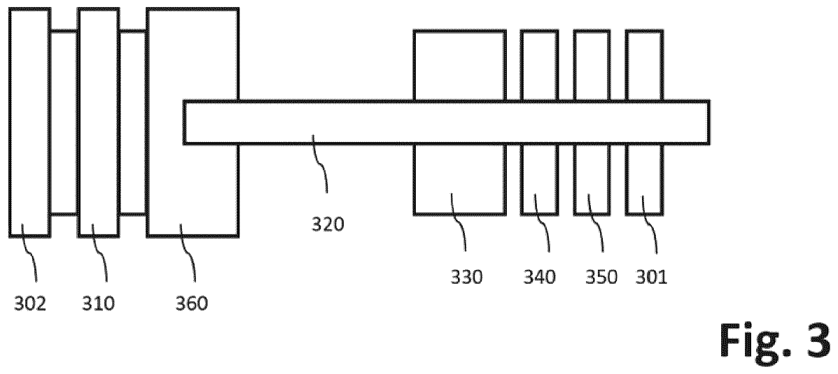

FIG. 3 shows a schematic drawing of a drive train for a robot joint with output-side torque sensor and angular position encoders on both sides according to an embodiment of the present disclosure.

An electric motor 330 drives a shaft 320 to rotate. A voltage converter 340 provides the necessary energy, while a motor electronic control system 350 controls the motor 330. The shaft 320 ends in a speed reducer 360 on the output side. The gearing mechanism, for example, provides a gear reduction.

A rotary encoder or angular position sensor 301 is arranged on the input side (input-side angular position sensor 301). Another rotary encoder or angular position sensor 302 is arranged on the output side (output-side angular position sensor 302). According to the disclosure, a torque output on the output side in the joint is determined by means of artificial intelligence from the measured values of the angular position sensors 301, 302 (and/or the difference between the measured values).

The torque can also be determined directly by a torque sensor on the output side. In particular, redundant torque determination is possible. This is particularly precise. Failure of the torque sensor is also prevented. In addition, the torque measured directly by the torque sensor can be used to train the AI in an outstanding manner.

For example, in continuous operation, the AI is further trained using the torque sensor.

Later, for example, the torque sensor can be removed, for example temporarily. But it can also remain there. If it fails at some point, the training is stopped and the excellently and extensively trained AI takes over the torque determination alone (based on the output values of the two encoders).

The disclosure has the further advantage that the AI, in particular through continuous training, dynamically takes into account environmental effects (e.g. temperature) as well as signs of wear, material fatigue, manufacturing tolerances of the components, etc.

The disclosure thus contributes to improved cobot control, as it can operate with a much more precisely determined torque output.

The technical effect of the disclosure therefore occurs when the torque determination is carried out redundantly (by rotary encoder+AI as well as directly by torque sensor), as well as when the torque sensor fails. In the latter case, downtime and faulty behavior of the cobot are avoided in particular.

This brings economic benefits.

The embodiments described schematically here can be further developed by numerous details of the disclosure, in particular by those already described above.

Although some aspects have been described in the context of a device, it is clear that these aspects also constitute a description of the corresponding method, wherein a block or device corresponds to a method step or a function of a method step. Similarly, aspects described in the context of a method step also represent a description of a corresponding block or element or a property of a corresponding device.

Exemplary embodiments of the disclosure can be implemented in a computer system. The computer system can be a local computer device (for example a personal computer, laptop, tablet computer, cell phone or an embedded control device in the robot) having one or more processors and one or more storage devices, or can be a distributed computer system (for example a cloud computing system having one or more processors or one or more storage devices distributed at various locations, for example, at a local client and/or one or more remote server farms and/or data centers). The computer system may comprise any circuit or combination of circuits. In one exemplary embodiment, the computer system may comprise one or more processors, which may be of any type. As used herein, processor may mean any type of computing circuit, such as, but not limited to, a microprocessor, a microcontroller, a complex instruction set computer (CISC), a reduced instruction set computer (RISC), a very long instruction word (VLIW) microprocessor, a graphics processor, a digital signal processor (DSP), a multi-core processor, a field-programmable gate array (FPGA), or any other type of processor or processing circuit. Other types of circuitry that the computer system may comprise may be a custom-built circuit, an application-specific integrated circuit (ASIC), or the like, such as one or more circuits (e.g., a communications circuit) for use with wireless devices such as cell phones, tablet computers, laptop computers, two-way radios, and similar electronic systems. The computer system may comprise one or more storage devices, which may comprise one or more storage elements suitable for the particular application, such as main memory in the form of random access memory (RAM), one or more hard disks, and/or one or more drives handling removable media such as CDs, flash memory cards, DVDs, and the like. The computer system may also comprise a display device, one or more speakers, and a keyboard and/or controller, which may include a mouse, trackball, touch screen, voice recognition device, or any other device that allows a system user to enter information into and receive information from the computer system.

Some or all of the method steps can be carried out by (or using) a hardware device, such as a processor, a microprocessor, a programmable computer or an electronic circuit. In some exemplary embodiments, one or more of the key method steps can be carried out by such a device.

Depending on certain implementation requirements, exemplary embodiments of the disclosure can be implemented using hardware or software. The implementation may be carried out with a non-volatile storage medium such as a digital storage medium, such as a floppy disk, a DVD, a Blu-Ray disk, a CD, a ROM, a PROM and EPROM, an EEPROM, or a FLASH memory on which electronically readable control signals are stored that interact (or can interact) with a programmable computer system to perform the respective method. Therefore, the digital storage medium can be computer-readable.

Some exemplary embodiments according to the disclosure comprise a data carrier with electronically readable control signals that can interact with a programmable computer system so that one of the methods described herein is carried out.

In general, exemplary embodiments of the present disclosure may be implemented as a computer program product having a program code, wherein the program code is effective for carrying out one of the methods when the computer program product is running on a computer. The program code can, for example, be stored on a machine-readable medium.

Further exemplary embodiments comprise the computer program for carrying out one of the methods described herein, which is stored on a machine-readable medium.

In other words, an exemplary embodiment of the present disclosure is therefore a computer program with a program code for carrying out one of the methods described herein when the computer program runs on a computer.

A further exemplary embodiment of the present disclosure is thus a storage medium (or data carrier or computer readable medium), comprising a computer program stored thereon for carrying out one of the methods described herein when executed by a processor. The data carrier, the digital storage medium or the recorded medium are usually tangible and/or non-transitory. A further exemplary embodiment of the present disclosure is a device as described herein, comprising a processor and the storage medium.

A further exemplary embodiment of the disclosure is therefore a data stream or a signal sequence representing the computer program for carrying out one of the methods described herein. For example, the data stream or signal sequence can be configured to be transmitted over a data communication connection, for example over the Internet.

Another exemplary embodiment comprises a processing means, for example a computer or a programmable logic device, configured or adapted to perform any of the methods described herein.

A further exemplary embodiment comprises a computer on which the computer program for carrying out one of the methods described herein is installed.

Another exemplary embodiment according to the disclosure comprises a device or system configured to transmit (e.g., electronically or optically) a computer program for carrying out one of the methods described herein to a receiver. The receiver may be, for example, a computer, a mobile device, a storage device or the like. The device or system may, for example, comprise a file server for transmitting the computer program to the receiver.

In some exemplary embodiments, a programmable logic device (e.g., a field programmable gate array, FPGA) may be used to perform some or all of the functionality of the methods described herein. In some exemplary embodiments, a field programmable gate array may cooperate with a microprocessor to carry out any of the methods described herein. In general, the methods are preferably carried out by each hardware device.

Exemplary embodiments may be based on the use of an artificial intelligence, in particular a machine learning model or machine learning algorithm. Machine learning can refer to algorithms and statistical models that computer systems can use in order to perform a certain task without using explicit instructions, rather than relying on models and inference. In machine learning, for example, instead of a transformation of data based on rules, a transformation of data can be used that can be derived from an analysis of historical and/or training data. For example, the content of images or other data, e.g. sensor data or measurement data, can be analyzed using a machine learning model or using a machine learning algorithm. In order for the machine learning model to analyze the content of an image, the machine learning model can be trained using training images as input and training content information as output. By training the machine learning model with a large number of training images and/or training sequences (e.g., words or sentences) and associated training content information (e.g., labels or annotations), the machine learning model “learns” to recognize the content of the images, so that the content of images not included in the training data can be recognized using the machine learning model. The same principle can also be used for other types of sensor data: By training a machine learning model using training sensor data and a desired output, the machine learning model “learns” a conversion between the sensor data and the output, which can be used to provide an output based on non-training sensor data provided to the machine learning model. The data provided (for example sensor data, metadata and/or image data) can be pre-processed in order to obtain a feature vector, which is used as input for the machine learning model.

Machine learning models can be trained using training input data. The examples above use a training method called supervised learning. In supervised learning, the machine learning model is trained using a plurality of training sample values, wherein each sample value can comprise a plurality of input data values and a plurality of desired output values, i.e., each training sample value is associated with a desired output value. By specifying both training sample values and desired output values, the machine learning model “learns” which output value is to be provided based on an input sample value that is similar to the sample values provided as part of the training. In addition to supervised learning, semi-supervised learning can also be used. In semi-supervised learning, some of the training sample values are missing a desired output value. Supervised learning can be based on a supervised learning algorithm (for example, a classification algorithm, a regression algorithm or a similarity learning algorithm). Classification algorithms can be used when the outputs are restricted to a limited set of values (categorical variables), i.e., the input is classified as one value of the limited set of values. Regression algorithms can be used if the outputs show any numerical value (within a range). Similarity learning algorithms can be similar to both classification and regression algorithms, but are based on learning from examples using a similarity function that measures how similar or related two objects are. In addition to supervised learning or semi-supervised learning, unsupervised learning can be used in order to train the machine learning model. In unsupervised learning, (only) input data may be provided and an unsupervised learning algorithm can be used to find a structure in the input data (for example, by grouping or clustering the input data, finding commonalities in the data). Clustering is the assignment of input data comprising a plurality of input values into subsets (clusters) so that input values within the same cluster are similar according to one or more (predefined) similarity criteria, while they are dissimilar to input values comprised in other clusters.

Reinforcement learning is a third group of machine learning algorithms. In other words, reinforcement learning can be used to train the machine learning model. In reinforcement learning, one or more software actors (i.e., “software agents”) are trained to perform actions in an environment. A reward is calculated based on the actions performed. Reinforcement learning is based on training one or more software agents to select actions such that the cumulative reward is increased, resulting in software agents that become better at the task given to them (as evidenced by increasing rewards).

Furthermore, some techniques can be applied to some of the machine learning algorithms. For example, feature learning can be used. In other words, the machine learning model may be trained at least in part using feature learning, and/or the machine learning algorithm may comprise a feature learning component. Feature learning algorithms, referred to as representation learning algorithms, can preserve the information in their input but transform it in a way that makes it useful, often as a preprocessing stage before performing classification or prediction. Feature learning can, for example, be based on principal component analysis or cluster analysis.

In some examples, anomaly detection (i.e., outlier detection) may be used, which aims to provide identification of input values that raise suspicion because they differ significantly from the majority of input data and training data. In other words, the machine learning model may be trained at least in part using anomaly detection, and/or the machine learning algorithm may comprise an anomaly detection component.

In some examples, the machine learning algorithm may use a decision tree as a prediction model. In other words, the machine learning model can be based on a decision tree. In a decision tree, the observations about an object (e.g., a set of input values) can be represented by the branches of the decision tree, and an output value corresponding to the object can be represented by the leaves of the decision tree. Decision trees can support both discrete values and continuous values as output values. If discrete values are used, the decision tree can be referred to as a classification tree; if continuous values are used, the decision tree can be referred to as a regression tree.

Association rules are another technique that can be used in machine learning algorithms. In other words, the machine learning model can be based on one or more association rules. Association rules are created by identifying relationships between variables in large data sets. The machine learning algorithm can identify and/or use one or more ratio rules that represent the knowledge derived from the data. The rules can be used, for example, to store, manipulate or apply the knowledge.

Machine learning algorithms are usually based on a machine learning model. In other words, the term “machine learning algorithm” can refer to a set of instructions that can be used to create, train, or use a machine learning model. The term “machine learning model” may refer to a data structure and/or a set of rules that represents the learned knowledge (e.g., based on the training performed by the machine learning algorithm). In exemplary embodiments, the use of a machine learning algorithm may imply the use of an underlying machine learning model (or a plurality of underlying machine learning models). The use of a machine learning model may imply that the machine learning model and/or the data structure/set of rules that constitutes the machine learning model is trained by a machine learning algorithm.

For example, the machine learning model can be an artificial neural network (ANN). ANNs are systems inspired by biological neural networks, such as those found in a retina or a brain. ANNs comprise a plurality of interconnected nodes and a plurality of connections, so-called edges, between the nodes. There are usually three types of nodes, input nodes that receive input values, hidden nodes that are (only) connected to other nodes, and output nodes that provide output values. Every node can represent an artificial neuron. Every edge can send information from one node to another. The output of a node can be defined as a (non-linear) function of the inputs (for example the sum of its inputs). The inputs of a node can be used in the function based on a “weight” of the edge or node providing the input. The weight of nodes and/or edges can be adjusted as part of the learning process. In other words, training an artificial neural network can comprise adjusting the weights of the nodes and/or edges of the artificial neural network, i.e., in order to achieve a desired output for a certain input.

Alternatively, the machine learning model can be a support vector machine, a random forest model or a gradient boosting model. Support vector machines (i.e., support vector networks) are supervised learning models with associated learning algorithms that can be used to analyze data (for example, in a classification or regression analysis). Support vector machines can be trained by providing an input with a plurality of training input values belonging to one of two categories. The support vector machine can be trained in order to assign a new input value to one of the two categories. Alternatively, the machine learning model can be a Bayesian network, which is a probabilistic-directed, acyclic graphical model. A Bayesian network can represent a set of random variables and their conditional dependencies using a directed acyclic graph. Alternatively, the machine learning model or its training can be based on a genetic algorithm, which is a search algorithm and heuristic technique that mimics the process of natural selection.

### LIST OF REFERENCE SIGNS

1 Angular position encoder/absolute encoder (input-side)
2 Angular position encoder/incremental rotary encoder (output-side)
3 Gearing mechanism
20 Drive shaft
100 Joint of a robot
202 Angular position encoder (output-side)
203 Gearing mechanism
210 Torque sensor (output-side)
301 Angular position encoder (input-side)
302 Angular position encoder (output-side)
310 Torque sensor (output-side)
320 Drive shaft
330 Motor/electromotor
340 Voltage converter/voltage source
350 Electronic control system/unit for motor
360 Speed reducer

1. A method for determining an output-side torque of an actuator gearing mechanism of a joint of a collaborative robot comprising:
receive input variables; and
executing a machine learning algorithm configured to implement a machine learning model, wherein the machine learning algorithm is configured to output one or more output variables on the basis of the input variables, wherein the input variables comprise:
a first angular specification corresponding to an input-side angular position; and
a second angular specification corresponding to an output-side angular position,
and wherein the output variables comprise the output torque determined by the machine learning algorithm.

2. The method according to claim 1, wherein the first angular specification is provided by an angular position sensor on the input side with respect to a gearing mechanism, and the second angular specification is provided by an angular position sensor on the output side with respect to a gearing mechanism.

3. The method according to claim 1, wherein the gearing mechanism comprises at least one of a stress wave gearing mechanism, a wave gearing mechanism, or a sliding wedge gearing mechanism.

4. A collaborative robot comprising:
a robotic device, in particular a robot arm and/or an assembly system, wherein the robotic device includes one or more joints which can be moved by motors;
at least one gearing mechanism;
one or more input-side angular position sensors to determine on the input side an input-side angular position with respect to the at least one gearing mechanism;
one or more output-side angular position sensors to determine on the output side an output-side angular position in relation to the gearing mechanism;
an electronic control system configured to take into account a value of a gearing mechanism-side outgoing torque during operation of the collaborative robot, provided by a machine learning algorithm, on the basis of data comprising:
an input-side angular position of an input-side angular position sensor; and
an output-side angular position of the corresponding output-side angular position sensor.

5. The collaborative robot according to claim 4, further comprising a torque sensor, wherein the output torque, provided by the machine learning algorithm, and a torque detected by the torque sensor complement each other,
wherein at least one of
a redundancy in the value determination of a torque is used to increase the precision of the value; or
the output torque is used if the torque sensor fails or provides false and/or compromised signals.

6. The collaborative robot according to claim 4, comprising at least one of a stress wave gearing mechanism, a wave gearing mechanism, or a sliding wedge gearing mechanism.

7. A method for operating the collaborate robot according to claim 4.

8. A computer system configured to execute the method of claim 7, wherein the computer system is configured locally to the collaborative robot or non-locally to the collaborative robot.

9. A computer system for determining an output side torque of an actuator gearing mechanism comprising:
one or more processors configured to execute a computer program stored in memory configured to cause the one or more processors to:
receive input variables, wherein the input variables comprise:
a first angular specification corresponding to an input-side angular position; and
a second angular specification corresponding to an output-side angular position,
execute a machine learning algorithm configured to implement a machine learning model, wherein the machine learning algorithm is configured to determine the output side torque of the actuator gearing mechanism based on the input variables and the machine learning model.

10. The computer system according to claim 9, wherein the machine learning algorithm comprises an unsupervised machine learning algorithm.

11. The artificial intelligence according to claim 9, wherein the input variables comprise: at least one of angular velocity, speed, acceleration or temperature.

12. A method for training the machine learning model according to claim 9 using
data relating to an input-side angular position and an output-side angular position of a gearing mechanism as input data.

13. The method according to claim 12, wherein a measured value of an output-side torque is further used as a target value as part of a feedback control loop.

14. The method according to claim 13, wherein the training is carried out continuously, wherein the training is aborted or interrupted if it is determined that the value of the output torque measured by a torque sensor is compromised or the corresponding signal is aborted.

15. A computer program comprising commands which, when the program is executed by a computer, cause the computer to carry out the method according to claim 7.

16. A use of a collaborative robot according to one of claim 4 for determining an output-side torque taking into account and for the purpose of taking into account one or more of the following effects: friction, wear, material fatigue, reversal margin, counter-reactions, other non-linear effects, manufacturing tolerances or individual differences in manufacturing or for the purpose of modelling dependencies of environmental and state variables by the machine learning algorithm.
